(19) United States
(12) Patent Application Publication
(10) Pub. No.: US 2006/0026803 A1
(43) Pub. Date: Feb. 9, 2006

(54) Connector device for suspending straps

(76) Inventor: Vincent Chang, Taichung (TW)

Correspondence Address: Charles E. Baxley, ESQ., 90 John Street, 3rd Floor, New York, NY, 10038, US

(21) Appl. No.: 10/913,629

(22) Filed: Aug. 9, 2004

(51) Int. Cl. B25B 25/00

(52) U.S. Cl. 24/68 CD

(57) ABSTRACT

A connector device includes a base coupled to a strap and having a chamber formed between two side panels and a bottom panel, each side panel includes a curved slot and a lock notch to slidably receive a shaft, two straps are coupled to the base, a frame is rotatably secured to the base with an axle and includes two side plates each having a channel to slidably receive the shaft, and to engage with and to move the shaft along the curved slots of the side panels. The shaft is engageable with the intermediate segment of one of the straps, and movable into the lock notches of the side panels, to tighten the strap. The frame may release the strap when the frame is rotated away from the lock notches of the side panels of the base.

### BACKGROUND OF THE INVENTION

1. Field of the Invention

The present invention relates to a connector device, and more particularly to a connector device for coupling or for suspending straps.

2. Description of the Prior Art

Typical connector devices for coupling or for suspending straps have been developed for coupling two straps together, and comprises a ring or loop for attaching or coupling to a lock device, and the straps are coupled to the loop and the lock device respectively, for allowing the straps to be coupled together by engaging the loop toward the lock device.

For example, U.S. Pat. No. 3,133,329 to Gaylord discloses one of the typical connector devices comprising a strap ring coupled to one of the straps, and a connector frame couple to the other strap, and the strap ring may be attached to the connector frame, and may be selectively locked to the connector frame with a swinging member and a tumbler.

However, the strap ring may only be coupled and secured to the lock device with the swinging member and the tumbler, but may not be used to straighten or tighten the straps, such that the length of the straps should be cut to the required or predetermined length before attaching to the strap ring and the lock device, and such that the straps may not be easily and quickly tightened and secured together.

The present invention has arisen to mitigate and/or obviate the afore-described disadvantages of the conventional connector devices.

### SUMMARY OF THE INVENTION

The primary objective of the present invention is to provide a connector device for allowing two straps to be easily and quickly tightened together.

In accordance with one aspect of the invention, there is provided a connector device comprising a base including a chamber formed therein and defined between two side panels and a bottom panel, each of the side panels including a curved slot and a lock notch formed therein and communicating with each other, an axle straddled between the side panels of the base, a shaft slidably engaged in the curved slots and engageable and lockable into the lock notches of the side panels of the base, a first strap attached to the base, a frame rotatably secured to the base with the axle, and rotatable relative to the base, and including two side plates each having a channel formed therein to slidably receive the shaft, and to engage with and to move the shaft along the curved slots of the side panels, and a second strap including an intermediate segment engaged over the axle and engaged around the shaft. The shaft is engageable with the intermediate segment of the second strap, and movable into the lock notches of the side panels, to force and to tighten the second strap when the frame is rotated relative to the base and locked to the base at a locking position, and the frame releases the intermediate segment of the second strap when the frame is rotated away from the lock notches of the side panels of the base.

The base includes a passage formed therein, the first strap is engaged through the passage of the base and coupled to the base. The base includes another passage formed therein, the second strap is engaged through the other passage of the base. The base includes a bar formed and defined by the passage of the base.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a connector device in accordance with the present invention;

FIG. 2 is a perspective view of the connector device;

FIG. 3 is a cross sectional view taken along lines 3-3 of FIG. 2, having two straps attached to the connector device;

FIG. 4 is a cross sectional view similar to FIG. 3, illustrating the operation or the other arrangement or application of the connector device.

### DETAILED DESCRIPTION OF THE PREFERRED EMBODIMENT

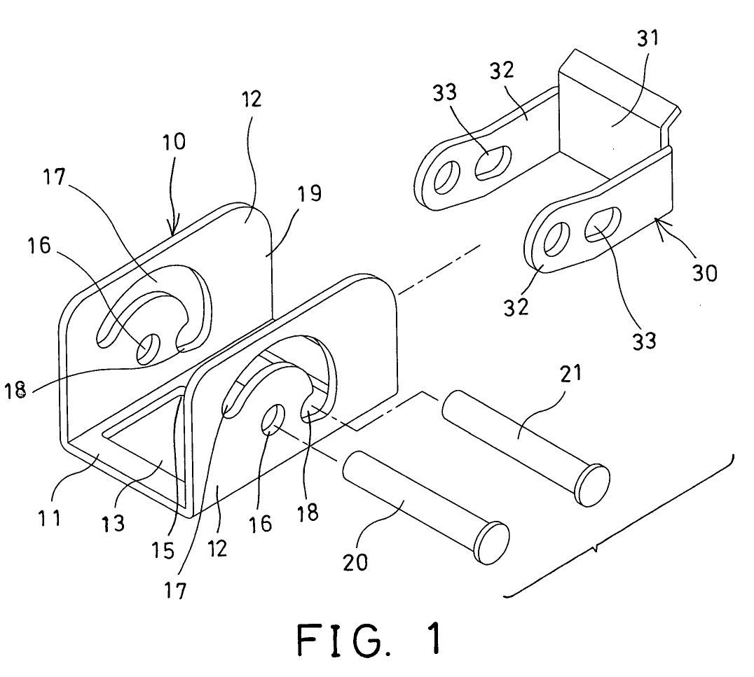

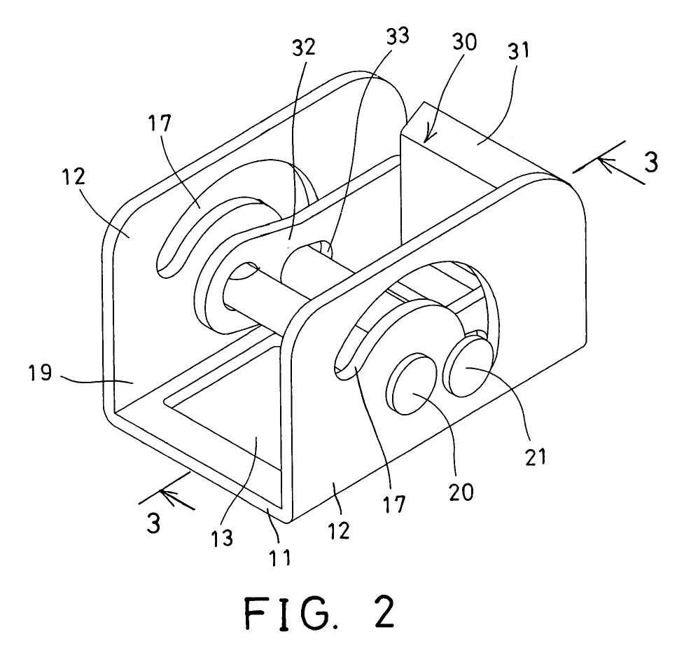

Referring to the drawings, and initially to FIGS. 1-3, a connector device in accordance with the present invention comprises a base 10 including a bottom panel 11 and two side panels 12 to form or define a chamber 19 between the side panels 12 and the bottom panel 11, and including one or more, such as two passages 13, 14 formed in the bottom panel 11 thereof, to define a bar 15 between the passages 13, 14 thereof. Each of the side panels 12 includes an orifice 16 formed therein and aligned with each other, to receive an axle 20 therein, and to allow the axle 20 to be straddled between the side panels 12.

The base 10 further includes two curved slots 17 formed in the side panels 12 respectively for slidably receiving a shaft 21 therein, and each of the two curved slots 17 of the side panels 12 includes a center of curvature located at the respective orifices 16 of the side panels 12. Each of the two curved slots 17 of the side panels 12 includes a lock notch 18 formed in one end thereof, and located closer to the respective orifices 16 of the side panels 12.

A connector frame 30 is received in the chamber 19 of the base 10, and is rotatably secured to the base 10 with the axle 20, and includes an upper plate or a handle 31, and two side plates 32 extended from and perpendicular to the handle 31. Each of the side plates 32 of the frame 30 includes an oblong hole or longitudinal channel 33 formed therein to slidably receive the shaft 21, and to engage with and to force the shaft 21 to move along the curved slots 17 of the side panels 12.

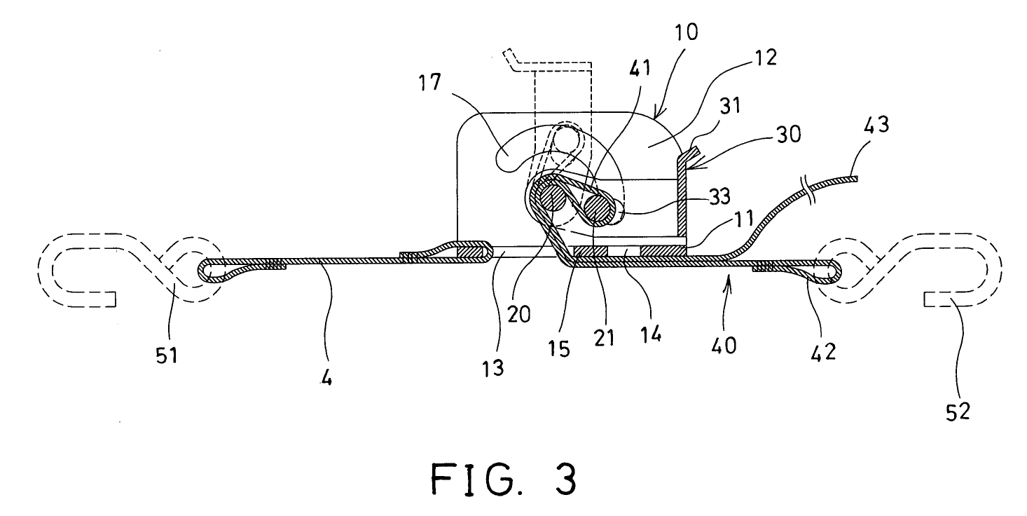

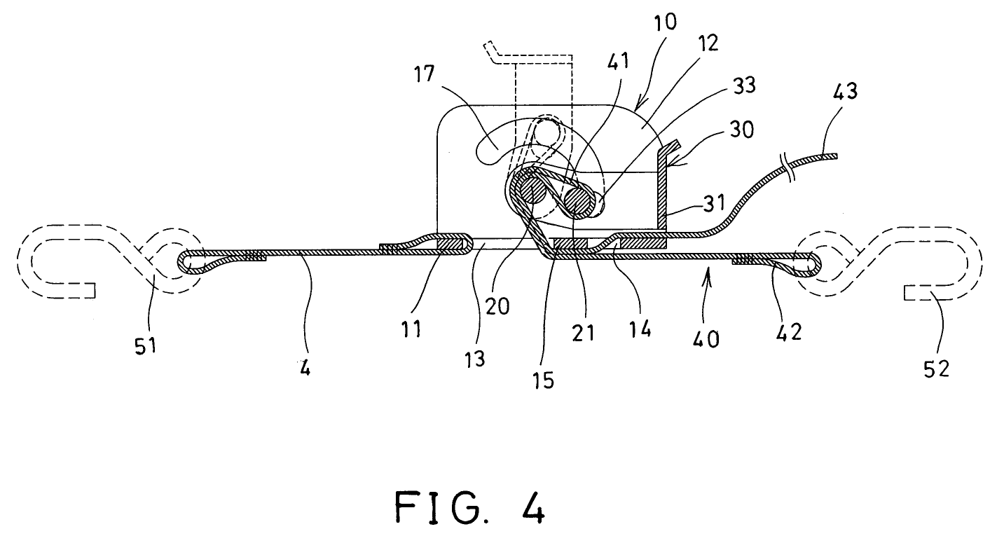

The longitudinal channels 33 of the side plates 32 of the frame 30 include a length slightly greater than the outer diameter of the shaft 21, to allow the shaft 21 to slide along the longitudinal channels 33 of the side plates 32, and to move into or to engage into the lock notches 18 of the side panels 12 (FIGS. 3, 4). In addition, the longitudinal channels 33 of the side plates 32 of the frame 30 include a suitable inclination to allow the side plates 32 of the frame 30 to engage with the shaft 21, and to move and to disengage the shaft 21 from the lock notches 18 of the side-panels 12 when the frame 30 is rotated upwardly relative to the base 10 or rotated away from the lock notches 18 of the side panels 12.

As shown in FIGS. 3-4, a strap 4 may be engaged through the passage 13 of the base 10, and coupled or secured to the base 10, and may be coupled to a hook 51 or the like. Another strap 40 may have an intermediate portion or segment 41 engaged through the passage 13 of the base 10, and engaged over the axle 20 and engaged around the shaft 21, and then engaged over the axle 20 again, and may have one end 42 coupled to another hook 52 or the like, and may have the other end 43 extended out of the base 10 and the frame 30.

Alternatively, as shown in FIG. 4, the other strap 40 may have the intermediate segment 41 engaged over the axle 20 and engaged around the shaft 21, and then engaged over the axle 20 again, and may then be engaged through the other passage 14 of the base, and may have the other end 43 extended out of the base 10 and the frame 30.

In operation, when the handle 31 of the frame 30 is pulled or forced or rotated upwardly relative to the base 10 or rotated away from the lock notches 18 of the side panels 12, the frame 30 may disengage the shaft 21 from the lock notches 18 of the side panels 12, as shown in dotted lines in FIGS. 3 and 4, and the shaft 21 may then be freely to slide along the curved slots 17 of the base 10, such that the strap 40 may be released, and such that the intermediate segment 41 of the strap 40 may be released by the shaft 21, and such that the strap 40 may be pulled or tightened relative to the base 10 or the other strap 4 at this moment, by such as pulling the other end 43 of the strap 40.

After the straps 4, 40 or the hooks 51, 52 have been tightened or forced or pulled toward each other by pulling the other end 43 of the strap 40, the frame 30 may then be forced toward the base 10, and may actuate or force the shaft 21 to move toward the lock notches 18 of the curved slots 17, and then the shaft 21 may be forced into the lock notches 18 of the base 10 by the strap 40, as shown in solid lines in FIGS. 3 and 4, such that the shaft 21 may engage with and may tighten the intermediate segment 41 of the strap 40.

It is to be noted that, when the frame 30 is rotated away from or is released from the base 10 to the released position as shown in dotted lines in FIGS. 3 and 4, the strap 40 may be easily and quickly pulled and tightened by pulling the other end 43 thereof, and then the frame 30 may be forced toward the base 10 to actuate the shaft 21 to tighten the intermediate segment 41 of the strap 40. The straps 4, 40 may thus be easily and quickly tightened and locked together by the relative movement between the base 10 and the frame 30 by forcing the shaft 21 into the lock notches 18 of the base 10.

Accordingly, the connector device in accordance with the present invention may be used for allowing two straps to be easily and quickly tightened together.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A connector device comprising:
a base including a chamber formed therein and defined between two side panels and a bottom panel, each of said side panels including a curved slot and a lock notch formed therein and communicating with each other,
an axle straddled between said side panels of said base,
a shaft slidably engaged in said curved slots and engageable and lockable into said lock notches of said side panels of said base,
a first strap attached to said base,
a frame rotatably secured to said base with said axle, and rotatable relative to said base, and including two side plates each having a channel formed therein to slidably receive said shaft, and to engage with and to move said shaft along said curved slots of said side panels, and
a second strap including an intermediate segment engaged over said axle and engaged around said shaft, and
said shaft being engageable with said intermediate segment of said second strap, and movable into said lock notches of said side panels, to force and to tighten said second strap when said frame is rotated relative to said base and locked to said base at a locking position, and said frame releasing said intermediate segment of said second strap when said frame is rotated away from said lock notches of said side panels of said base.

2. The connector device as claimed in claim 1, wherein said base includes a passage formed therein, said first strap is engaged through said passage of said base and coupled to said base.

3. The connector device as claimed in claim 1, wherein said base includes a passage formed therein, said second strap is engaged through said passage of said base.

4. The connector device as claimed in claim 3, wherein said base includes a bar formed and defined by said passage of said base.
